(19) United States
(12) Patent Application Publication
(10) Pub. No.: US 2006/0076786 A1
(43) Pub. Date: Apr. 13, 2006

(54) Doorjam configured on a door handle

(76) Inventor: Farzad Shaygan, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/241,371

(22) Filed: Sep. 30, 2005

Related U.S. Application Data
(60) Provisional application No. 60/614,851, filed on Sep. 30, 2004.

(51) Int. Cl. E05C 19/18

(52) U.S. Cl. 292/288

(57) ABSTRACT

According to one embodiment of the present invention, a doorjam is provided, the doorjam comprising a main body having a gap therethrough and a handle portion to facilitate grasping the doorjam. The gap in the main body may be configured to slidably engage a handle of a door, and the main body may have a width sufficient to contact the door and a stationary member.

### RELATED APPLICATIONS

This application claims priority under 35 U.S.C. § 119(e) to U.S. Provisional Application No. 60/614,851 filed on Sep. 30, 2004, the entirety of which is hereby incorporated by reference.

### BACKGROUND OF THE INVENTION

1. Field of the Invention

Preferred aspects of the present invention relate to a doorjam. Preferred embodiments of the present invention are particularly useful for preventing an outwardly swinging door to be opened from the outside using a simple doorjam mechanism.

2. Description of the Related Art

Doorjams are typically inserted at the bottom of inwardly swinging doors. They are used to prevent these doors from opening and function by wedging between the bottom of the door and the floor. Typically, such doorjams are made of relatively pliable materials, such as rubbers, woods, plastics, etc. When someone attempts to open the door from the outside, the friction between the floor and the doorjam prevents the door from opening.

Unfortunately, such a doorjam design clearly does not work to prevent an outwardly swinging door from swinging outwardly. In many typical office settings, the doors open outwardly, and there is therefore no way to simply and temporarily block the opening of the door by use of a removable doorjam, such as those in the prior art. Instead, the door must be locked or blocked with a more expensive and complicated device. Thus, reception personnel in office buildings may be at risk of being assaulted, robbed, solicited, etc.

It is an object of this invention, therefore, to provide a doorjam-like article that can simply, effectively and temporarily prevent an outwardly swinging door from opening.

### SUMMARY OF THE INVENTION

According to one embodiment of the present invention, a doorjam is provided, the doorjam comprising a main body having a gap therethrough. The gap in the main body may be configured to slidably engage a handle of a door, and the main body may have a width sufficient to contact the door and a stationary member.

### BRIEF DESCRIPTION OF THE DRAWINGS

The preferred embodiments of this invention, illustrating all its features, will now be discussed in detail. These embodiments depict the novel and nonobvious method and doorjam of this invention shown in the accompanying drawings, which are for illustrative purposes only. The drawings include the following Figures, with like numerals indicating like parts.

FIG. 1 shows a perspective view of one embodiment of a doorjam in keeping with the present invention.

FIG. 2 shows a front view of the doorjam of FIG. 1.

FIG. 3 shows a bottom view of the doorjam of FIG. 1.

FIG. 4 shows a front view of another embodiment of a doorjam.

FIG. 5 shows a perspective view of the doorjam of FIG. 1 in an engaged configuration with a door.

### DETAILED DESCRIPTION OF THE PREFERRED EMBODIMENT

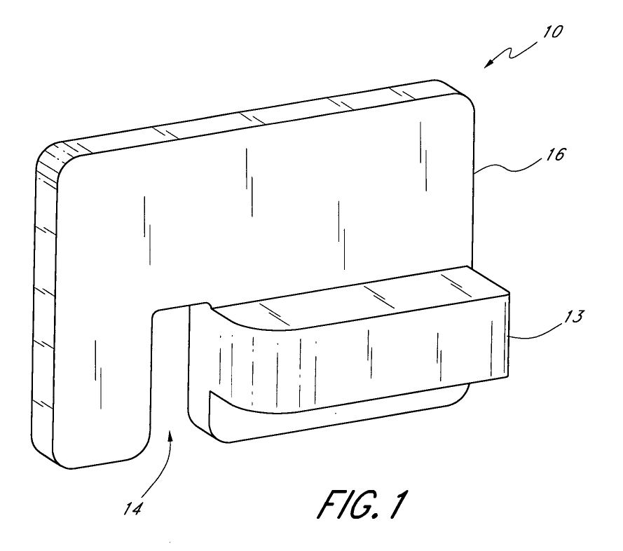

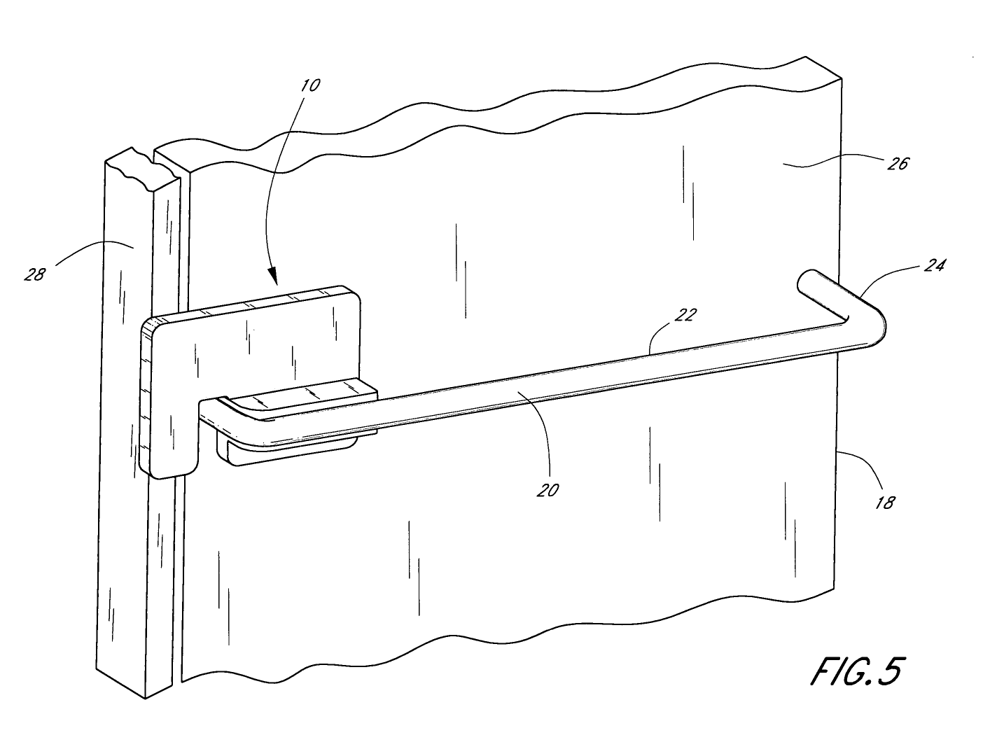

FIG. 1 illustrates one embodiment of a doorjam that may be used to temporarily block an outwardly swinging door. The doorjam 10 may be used to block a number of differently configured doors, and one embodiment of the doorjam 10 is shown in an engaged configuration with one particular door in FIG. 5.

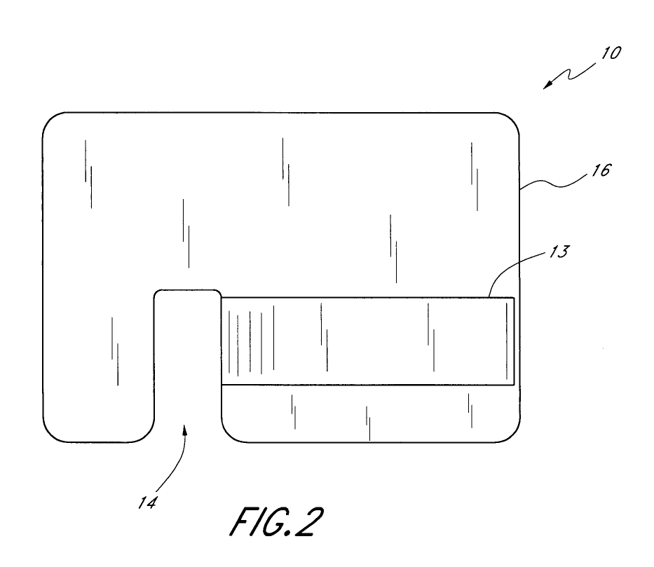

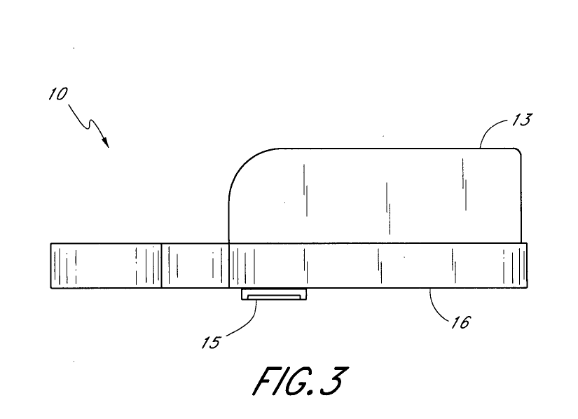

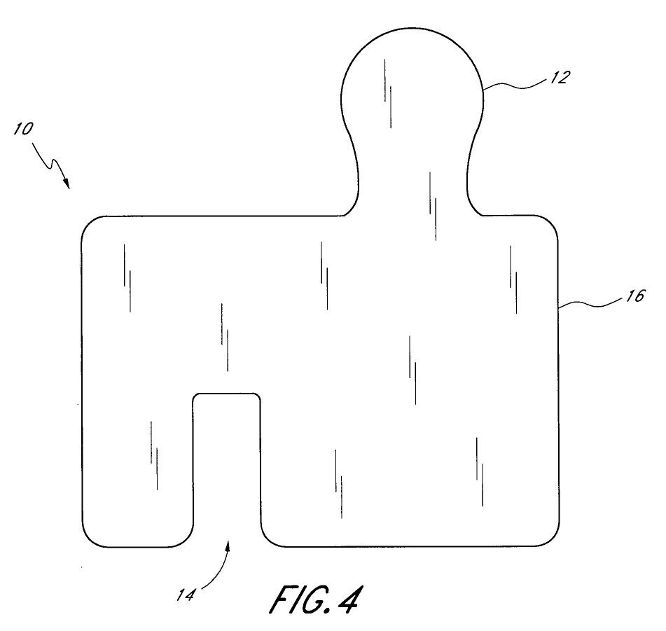

In the embodiment illustrated in FIGS. 1, 2 and 3 the doorjam 10 comprises a main body 16, a first securing portion 13, a second securing portion 15, and a gap 14 in the main body 16. In other embodiments, the doorjam 10 may also include a handle portion 12 to provide some purchase by which a user can more easily grasp the doorjam 10. The handle portion 12 may have a generally knob shape (as in FIG. 4), a generally rectangular shape, or any other shape that facilitates grasping by a user.

The gap 14 is preferably configured to fit over a doorknob or handle affixed to a door. In one embodiment, the gap 14 should be precisely sized, such that the doorjam 10 can sit above a handle with the gap 14 facing the ground without the doorjam 10 rotating out of engagement with the handle. Such a configuration is shown in FIG. 5. The gap 14 and main body 16 are also preferably configured to fit closely between a surface of a door and a part of the handle of the door that is varying in shape or configuration. Thus, the gap 14 and main body 16 are less likely to move out of blocking engagement with the door by sliding back and forth along the handle.

In one embodiment, the doorjam 10 comprises a unitary piece of polymer. In other embodiments, the doorjam 10 may be manufactured from a variety of materials and need not be formed from the same material throughout. For example, the handle portion may be made of a different material to enhance the doorjam's aesthetic appeal.

In FIG. 5, the doorjam 10 of FIG. 1 is shown in an engaged and blocked configuration with a door 18. This door 18, like many office doors, has disposed on the inside a curved handle 20. The curved handle 20 has a parallel portion 22 running relatively parallel to the plane of the door, and a perpendicular portion 24 that extends from the door 18 at close to a right angle.

As discussed above, the width of the gap 14 of the doorjam 10 is preferably configured to fit the handle 20 snugly within it. The doorjam 10 is preferably configured such that it fits tightly between a surface 26 of the door 18, and the parallel portion 22 of the handle 20. In some embodiments, the first securing portion 13 and the second securing portion 15 are sized such that the door jam 10 fits snugly between the surface 26 and the handle 20. Preferably, the first securing portion 15 is sized and shaped to contact a portion of the handle 20 and provide a snug fit when the door jam 10 is inserted between the handle 20 and the surface 26. Therefore, the doorjam 10 is relatively secure on the handle 20. In some embodiments, the second securing portion 15 abuts a frame portion of a door that extends along the perimeter of the door. The securing portions (13, 15) are not essential, as achieving the snug fit when the main body 16 of the doojam 10 is inserted between the surface 26 of the door 18 and the handle 20 may be achieved in any suitable manner.

The width of the main body 16 is further configured to extend beyond the surface 26 of the door 18 when the doojam 10 is in an engaged configuration. In a preferred embodiment, the doorjam 10 thereby extends in front of a stationary member 28. This stationary member 28 may be any of a variety of stationary objects typically found with doors, such as door frames, door supports, split door dividers, etc.

Since the doorjam 10 abuts this stationary member 28, the door 18 may not be opened outwardly. As someone pulls from the side of the door opposite the illustrated surface 26, the doorjam 10 cannot pass by the stationary member 28 and cannot be moved from its position on the handle 20 because it abuts the parallel portion 22 of the handle 20. Thus, the door 18 cannot be opened unless the doorjam 10 is first removed. Such a doorjam 10 is clearly very simple to operate, and may be used in a variety of environments.

Although not shown, such a doorjam may be used on a door knob or otherwise configured door handle, as long as it fits around the handle and is wide enough to abut some stationary element. In addition, the doorjam may be configured to engage a wide variety of handles and may be locked by some means about the handle.

Although the present invention has been described in terms of certain preferred embodiments, other embodiments of the invention including variations in dimensions, configuration and materials will be apparent to those of skill in the art in view of the disclosure herein. In addition, all features discussed in connection with any one embodiment herein can be readily adapted for use in other embodiments herein. The use of different terms or reference numerals for similar features in different embodiments does not imply differences other than those which may be expressly set forth. Accordingly, the present invention is intended to be described solely by reference to the appended claims, and not limited to the preferred embodiments disclosed herein.

What is claimed is:

1. A doorjam, comprising:
a main body having a gap therethrough;
wherein the gap is configured to slidably engage a handle of a door, and the main body has a width sufficient to contact the door and a stationary member.

2. The doorjam of claim 1 further comprising a handle.
